(19) United States
(12) Patent Application Publication
(10) Pub. No.: US 2008/0235332 A1
(43) Pub. Date: Sep. 25, 2008

(54) Advertising substitution payment system

(75) Inventors: Jeffrey A. McChesney, Ridgefield, CT (US); Thomas P. McClain, Ridgefield, CT (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: Venture Capital & Consulting Group, LLC, Ridgefield, CT (US)

(21) Appl. No.: 12/077,905

(22) Filed: Mar. 21, 2008

Related U.S. Application Data
(60) Provisional application No. 60/919,237, filed on Mar. 21, 2007.

(51) Int. Cl. G06F 15/16

(52) U.S. Cl. 709/204

(57) ABSTRACT

There is provided a method that includes sending information to a first device, receiving a confirmation that a user of the first device acknowledged receipt of the information, and facilitating a communication between the first device and a second device via a peer-to-peer network in return for the confirmation.

### BACKGROUND OF THE INVENTION

1. Field of the Invention

The present disclosure relates to facilitating communication between devices on a peer-to-peer (P2P) network, and more particularly, to facilitating communication between devices on a peer-to-peer network in return for a user reviewing an advertisement.

2. Description of the Related Art

There is presently no ability for users of a subscription-based or transaction-based P2P network to accrue credits for access to such network, except for direct payment methods. In particular, there is no ability to pay for voice over Internet protocol (VOIP) calls to local exchanges with advertisement credits, and no ability for P2P users to choose to receive advertisements to accrue credits while connected to a P2P network, in lieu of direct financial payments for access thereto. There is also no way for an advertiser to target advertisement content to various segments of P2P users of a network, from generalized 1-to-1 targeting.

Presently, P2P networks do not attach metadata to data packets transmitted therethrough, for the purpose of encoding credits earned by a user for viewing advertisements. Further, there is a lack of knowledge and understanding of the use of generalized and targeted advertisements as an alternative to financial payments for access to P2P networks.

The present invention addresses the foregoing, and other shortcomings in the art.

### SUMMARY OF THE INVENTION

There is provided a method that includes sending information to a first device, receiving a confirmation that a user of the first device acknowledged receipt of the information, and facilitating a communication between the first device and a second device via a peer-to-peer network in return for the confirmation.

### BRIEF DESCRIPTION OF THE DRAWINGS

Various aspects of the present invention will be better understood with reference to the drawings. A component or a feature that is common to more than one drawing is indicated with the same reference number in each of the drawings, in which:

FIG. 1 is a functional block diagram of an advertising substitution payment system.

FIG. 2 is a functional block diagram of interaction between a service provider and a user device in the system of FIG. 1.

FIG. 3 is a user interface for a user device shown in FIG. 1.

### DESCRIPTION OF THE INVENTION

A P2P computer network uses diverse connectivity between participants in a network and the cumulative bandwidth of network participants rather than conventional centralized resources where a relatively low number of servers provide the core value to a service or application. P2P networks are typically used for connecting nodes via largely ad hoc connections. Such networks are useful for many purposes. Sharing content files containing audio, video, data or anything in digital format is very common. Real-time data, such as telephony traffic, is also passed using P2P technology.

Nodes on a pure P2P network are sensibly classed neither as clients nor servers, but rather only as equal peer nodes that simultaneously exhibit client and server functions to one another. This network topology differs from the client-server model where communication is usually to and from a central server.

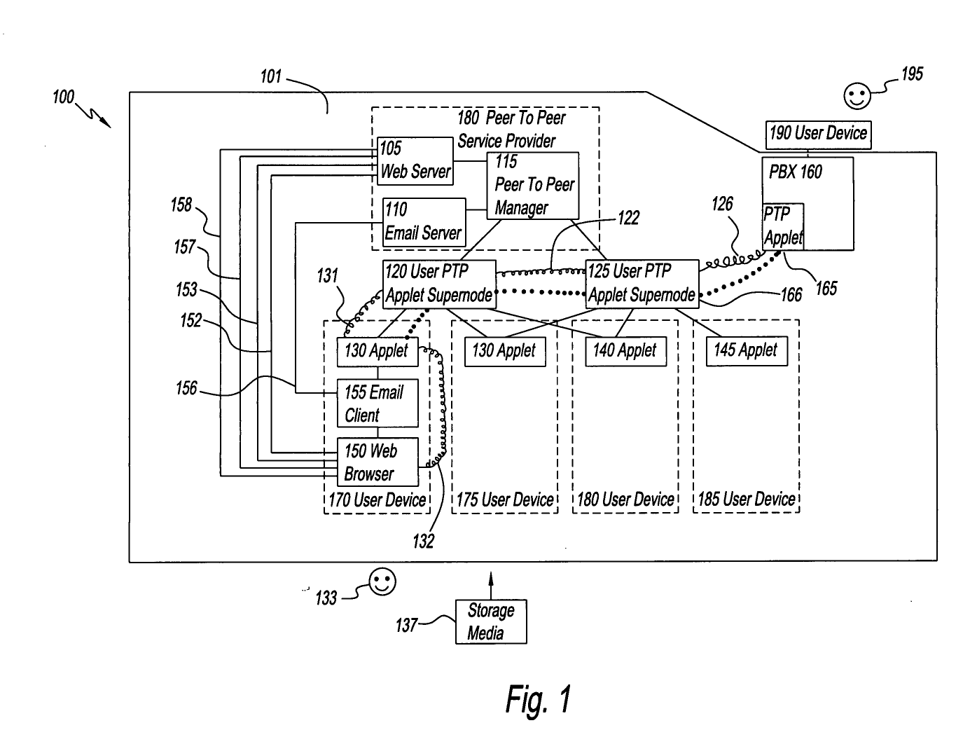

FIG. 1 is a functional block diagram of an advertising substitution payment system, hereinafter referred to as system 100. System 100 includes a P2P network 101 that is implemented over the Internet, and that, in turn, includes a P2P service provider 180, a plurality of user devices 170, 175, 180, 185, supernodes 120 and 125, and a private branch exchange (“PBX”) 160. PBX 160 is coupled, via a public switched telephone network (PSTN) (not shown), to a user device 190 that is external to P2P network 101. User device 190 could be, for example, a land line telephone or a mobile, e.g., cellular or satellite, telephone.

P2P service provider 180 is implemented on a device having a processor (not shown) and a memory that includes instructions in modules for controlling the processor, namely a webserver 105, an e-mail server 110, and a P2P manager 115. User device 170 is implemented on a device having a processor (not shown) and a memory that includes instructions in modules for controlling the processor, namely a web browser 150, an e-mail client 155 and an applet 130. User device 170 also includes components through which user 133 can conduct communication, e.g., a display, keyboard, microphone and a speaker. The term “module” is used herein to denote a functional part that may be embodied either as a stand-alone component or as an integrated configuration of a plurality of subordinate components. Steps associated with the operations of P2P manager 115 and applet 130 can be performed in any order, unless otherwise specified or dictated by the steps themselves.

In FIG. 1, applet 130 is shown as a component of user device 170. However, applet 130 was previously installed into user device 170 as follows. At the behest of a user 133, e-mail client 155 sends a request to P2P service provider 180, via a communication 156, to sign up for a P2P communications service. The request may optionally be accompanied by a fee for services and software downloads. The request is communicated to e-mail server 110, and from e-mail server 110 to P2P manager 115 for processing. P2P manager 115 processes the request and sends a P2P software applet and secure password through webserver 105, via a communication 152, to web browser 150. User device 170 installs the P2P applet as applet 130. Applets 135, 140 and 145 are installed on user devices, 175, 180 and 185, respectively, in a manner similar to that of applet 130 being installed on user device 170, and an applet 165 is installed in PBX 160.

Applets 130, 135, 140, 145 and 165 enable P2P communications between user device 170, user device 175, user device 180, user device 185 and PBX 160. Whereas user devices 170, 175, 180 and 185 include applets 130, 135, 140 and 145, respectively, user device 170 is able to conduct communications with any of user devices 175, 180 and 185. User device 170 can also conduct communications with user device 190 via applet 165. Such communication may involve any type of data that is suitable for transmission via P2P network 101, including VOIP telephony.

Supernodes 120 and 125 perform processing that need not be performed by a centralized server farm. Each of supernodes 120 and 125 manages functionality for itself and a number of designated nodes. A supernode may simultaneously perform the functions of an applet, e.g., applet 130. Any of applets 130, 135, 140, 145 can be a node that manages limited functionality, principally for itself, or for a supernode, e.g., supernode 125. P2P manager 115 also transmits lists of users, data about the user, and a master list of public telephone exchange Internet protocol (IP) addresses to supernodes 120 and 125.

User 133 may be required to pay a fee for the privilege of conducting communications via P2P network 101. Such a fee is even more likely in a case where user 133 wishes to conduct a communication with a user 195 of user device 190, since user device 190 is not within P2P network 101, and the communication would be routed through a PSTN. Moreover, the communications between user device 170 and user device 190 may require a payment by one or both of user 133 and user 195. The payment can be made by the purchase of credits by user 133.

As an alternative to the purchasing of credits, P2P service provider 180 can grant credits to user 133 in exchange for user 133 accepting a presentation of information. The information can be in any suitable form, such as textual, graphical, or audio form, and may include an advertisement. This alternative is referred to herein as an advertising substitution payment, and is accomplished with the consent of user 133. Indeed, user 133 opts into a program for the payment by advertising substitution, either by affirmatively requesting permission to participate, or by affirmatively responding to an invitation to participate.

For example, assume that user 133 wishes to place a call to user device 190. Through a user interface with applet 130, user 133 indicates a desire to participate in the advertising substitution payment system. Thus, via the user interface, applet 130 receives a prompt, from user 133, indicating that user 133 has consented to receive an advertisement. Applet 130 sends a message to P2P manager 115, indicating that user 133 has consented to receive the advertisement, and P2P manager 115, in response to receipt of the message, sends the advertisement to applet 130. Applet 130 presents the advertisement via the user interface, and waits for a confirmation that user 133 received the advertisement. The confirmation can be in the form of an input, by user 133, evidencing that user 133 considered some content in the advertisement, e.g., user 133 is required to answer a question regarding the content. Nevertheless, applet 130, upon receipt of the confirmation that user 133 received the advertisement, sends a further confirmation to P2P manager 115. P2P manager 115 then sends a message to applet 130 to enable user device 170 to communicate with user device 190 via P2P network 101. Thus, P2P manager 115 and applet 130 cooperate with one another to facilitate the communication between user device 170 and user device 190, via P2P network 101, in return for the confirmation from user 133.

The facilitation of a particular communication between user device 170 and user device 190 does not necessarily require participation by P2P manager 115. For example, applet 130 may include, encoded therein, a collection of advertisements. Accordingly, applet 130 after the receipt of the prompt from user 133 indicating that user 133 has consented to receive an advertisement, presents an advertisement from the collection via the user interface. Applet 130 waits for a confirmation that user 133 received the advertisement, and thereafter, facilitates the communication via P2P network 101.

Also, although the operation of system 100 is described above in the context of a communication between user device 170 and user device 190, which is external to P2P network 101, the payment substitution can also be employed to facilitate a communication user device 170 and a user device that is within P2P network 101, e.g., user device 175.

Communication between user device 170 and any other device, either within P2P network 101 or beyond P2P network 101, begins with user 133 supplying login credentials, via user device 170, to applet 130. The login credentials are communicated, via a communication 153, to P2P service provider 180.

The login having thus been performed, user device 170 initiates communication through applet 130, via a channel 131, to supernode 120. Supernode 120 validates data packets, changes data packets as required, and then communicates data to supernode 125. More particularly, supernode 120 sends communication, e.g., a “call”, via a channel 122 to supernode 125. In so doing, supernode 120 attaches the IP address of, credit available to, and destination phone number to be reached from, user device 170 for the call. Supernode 120 sends the call, i.e., data packets that comprise “the call”, to PBX 160 via supernode 125 and a channel 126. Communications between PBX 160 and supernode 125 are mediated by a P2P applet 165.

PBX 160 in turn prepares to send the call onward to user device 190. Concurrently, PBX 160 transmits call charge information, via a communication 166 (designated by a heavy dotted line), to supernode 125, through supernode 120, to applet 130.

Upon receipt of the call charge information, applet 130 debits an account associated with user device 170. When the account has a value that is less than a threshold, user 133's call is interrupted, and one or both of user 133 and user 195 is/are notified by P2P service provider 180 that the call will be terminated unless more credits are purchased, or unless one or both of user 133 and user 195 agrees to request and review an advertisement. Optionally, P2P service provider 180 may request that user 133 or user 195 review a message to accrue credits that can be applied to a further service.

Determination of the threshold can be done in one or a combination of several ways. One way is by simple comparison of remaining credits to a predetermined number. For example, user 133 could be notified when there are ten or fewer credits remaining. Another way is to determine a credit expenditure rate, and notify user 133 when a certain amount of time remains until available credits are expected to be exhausted.

If user 133 decides to purchase credits then the following takes place. Applet 130, via a channel 132, places a data call through web browser 150 to P2P service provider 180, via a communication 157. Applet 130 sends P2P service provider 180 user 133's credit card data and a quantity of credits to be ordered. To finalize this purchase of credits, webserver 105 communicates the order to P2P manager 115, which processes credit information to grant the credits. Next, P2P manager 115 transmits credits through webserver 105, via a communication 158, to web browser 150. Thus user device 170's credits are replenished.

Alternatively to user 133 replenishing credits on user device 170 by purchase, as described above, user 133 or user 195 can agree to view or hear a message, in exchange for which viewing or hearing, there is a replenishment of credits on user device 170 sufficient to continue the interrupted call.

Although system 100 is described herein as having P2P manager 115 installed in a memory of P2P service provider 180, and having applet 130 installed in a memory of user device 170, either or both of P2P manager 115 and applet 130 can be tangibly embodied on an external computer-readable storage media 137 for subsequent loading into P2P service provider 180 and user device 170, respectively. Storage media 137 can be any conventional storage media, including, but not limited to, a floppy disk, a compact disk, a magnetic tape, a read only memory, or an optical storage media. The instructions could also be embodied in a random access memory, or other type of electronic storage, located on a remote storage system and coupled to P2P service provider 180 or user device 170. Moreover, although P2P manager 115 and applet 130, are described herein as being installed in P2P service provider 180 and user device 170, and therefore being implemented in software, they could be implemented in any of hardware, firmware, software, or a combination thereof.

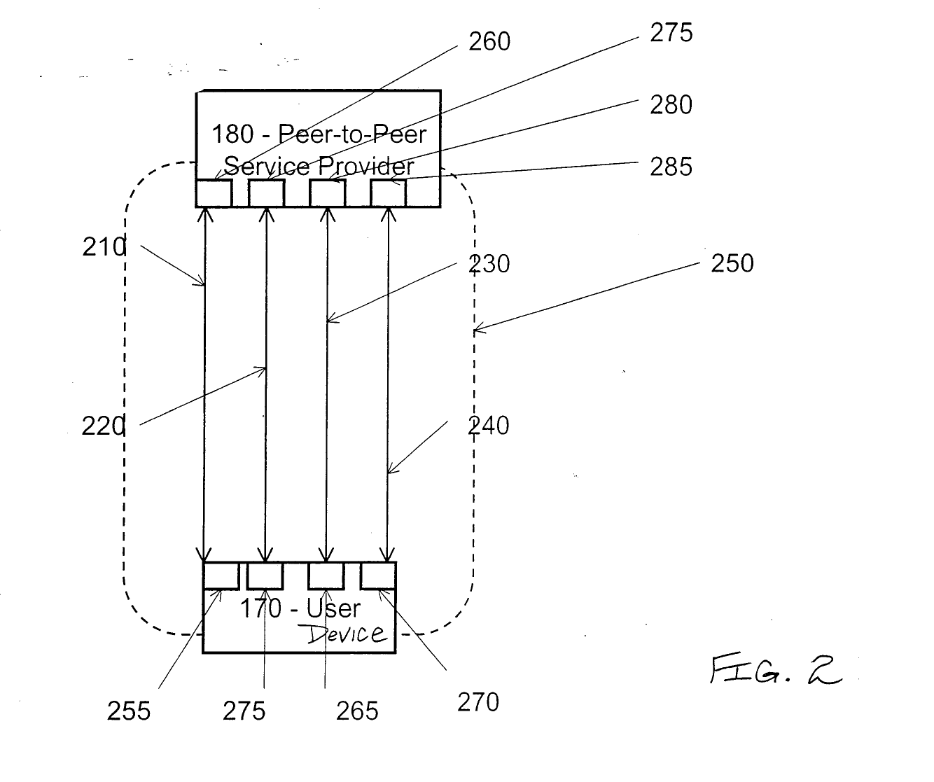

FIG. 2 is a functional block diagram of interaction between P2P service provider 180 and user device 170 communicating through a P2P network 250, when user 133 opts to review a message in exchange for credits.

Between P2P service provider 180 and user device 170 there is a plurality of communications 210, 220, 230, 240. Communications 210, 220, 230, and 240 can be packet-based communications such as transmission control protocol/Internet protocol (TCP/IP).

Communication 210 begins when user 133 initiates a request to receive a message, which user 133 accomplishes by selecting a digital soft switch or push button, i.e., a button 255, on user device 170. Button 255 having been selected, a digital transmission, i.e., a data call, to P2P service provider 180 is initiated. P2P service provider 180 then, in a process 260, computes the request to review the message in lieu of payment. P2P service provider 180 next responds to user device 170 with a communication 220.

Communication 220 is a digital transmission of a message 275. Message 275 may be rendered by user device 170 in audio, visual, or indeed any human-perceptible form.

User 133 reviews message 275 via a user interface of user device 170. Message 275 may prompt user 133 to complete certain actions, such as to indicate that user 133 has read message 275 in its entirety. When user 133 has completed the actions, applet 130 generates a confirmation 265 that indicates user 133's receipt and review of message 275, and initiates a communication 230.

In communication 230, applet 130 transmits confirmation 265 to P2P service provider 180. P2P service provider 180 then computes a credit count 280, and initiates a communication 240.

In communication 240, P2P service provider 180 transmits credits 285 to applet 130. The quantity of credits 285 is reflective of credit count 280. User device 170 thus has credits 285 available for immediate use to continue with a call that is in process, or to make other calls.

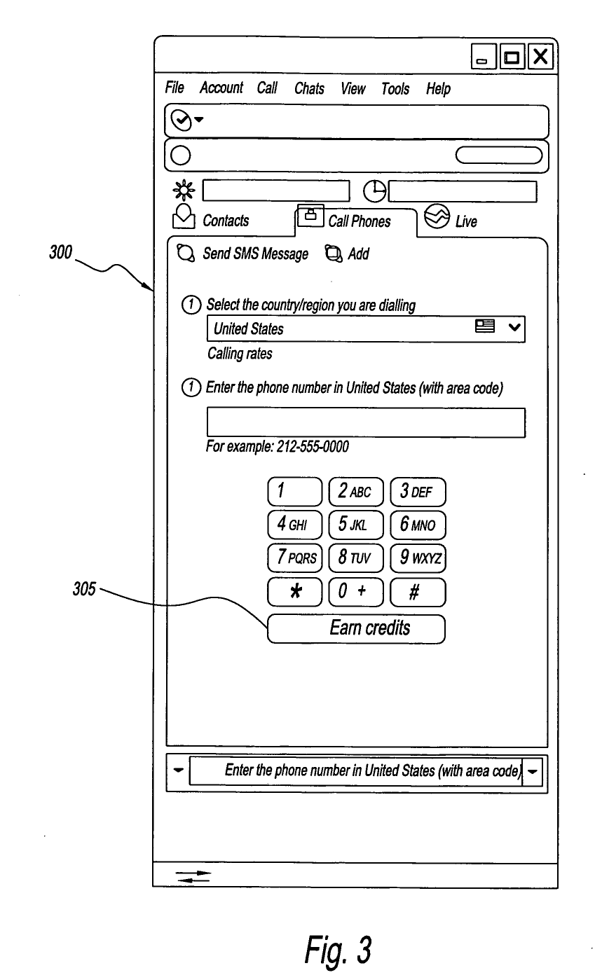

FIG. 3 is an illustration of a user interface for communication between user 133 and applet 130. User interface 300 includes a button 305, which is an implementation of button 255, mentioned above, or indeed any suitable user interest-notating device. User 133 employs button 305 to indicate his willingness to view message 275. In exchange for user 133 confirming review of message 275, which review may take place via user interface 300, user 133's user device 170 will receive credits 285.

In system 100, user 133 can accrue credits for various uses by choosing to receive advertisements in lieu of making direct financial payments to an P2P service provider 180. The perception of user 133 is that the call becomes free. System 100 enables:
1. peer-to-peer users to earn credits by engaging in targeted advertisements;
2. peer-to-peer network owners to create a new financial mechanism for users to earn credits, rather to pay for them, that will unleash additional revenue streams and wider market acceptance and penetration;
3. creation of advertisement metadata to be managed on a distributed basis through a peer-to-peer network, dramatically reducing the overhead costs and processing required at a centralized server;
4. provision of engaging and useful advertisement opportunities to brands and advertisers to an untapped audience at the point of need;
5. greatly enhanced user options for payment choices;
6. effective and distributed advertising measurement system;
7. economic incentives to create new advertisement and peer-to-peer products for the benefit of all Internet users;
8. expansion of the payment choices for all Internet users for services across the Internet; and
9. an innovative advertisement-based system to accelerate adoption and use of the Internet for enhanced capabilities.

In an exemplary embodiment of the invention, in a P2P network with VOIP, a P2P user initiates the applet to complete a VOIP-to-telephone call to an outside user through a PBX or a PSTN, usually for a financial charge. The telephone call consists of a landline connection. In another embodiment it consists of a mobile phone connection. In both cases, the P2P user, and sometimes the outside user, are charged for the connection. By employing a button on the user interface, e.g., see FIG. 3, the user elects to receive and review an advertisement (aural and/or visual) prior to placing the call, in lieu of financial charges, in various forms of compensation. This compensation then accrues credits for connection charges, so that financial charges are not incurred.

In another embodiment, the P2P user initiates the applet to access a user interface, e.g., see FIG. 3, during a VOIP-to-telephone call to an outside user, which interrupts the connection, to receive and review an advertisement, prior to the available credits reaching zero and having the call disconnected due to insufficient funds.

In another embodiment, the outside user receives a request to receive and review an advertisement during the VOIP-to-telephone, prior to the P2P user's connection being terminated.

In another embodiment, both the P2P user and outside user initiate and request to receive an advertisement prior to the termination of the VOIP-to-telephone connection.

In another embodiment, a P2P user downloads the P2P applet with an advertisement already included in the software and an agreement to review the advertisement as credit for VOIP-to-telephone calls. Upon executing the software, the P2P user receives and reviews the advertisement and gains credit for a future VOIP-to-telephone call.

In another embodiment, a P2P user purchases the P2P applet for a fee, with an advertisement already included in the software, and an agreement to review the advertisement for greater compensation. After the P2P applet is installed, the P2P user receives and reviews the advertisement and then receives direct compensation, instead of credit for a VOIP-to-telephone connection.

In another embodiment, the P2P network service provider requests the P2P user to receive and review an advertisement to accrue credits for services, in lieu of charges.

The techniques described herein are exemplary, and should not be construed as implying any particular limitation on the present invention. It should be understood that various alternatives, combinations and modifications could be devised by those skilled in the art. The present invention is intended to embrace all such alternatives, modifications and variances that fall within the scope of the appended claims.

What is claimed is:

1. A method comprising:
sending information to a first device;
receiving a confirmation that a user of said first device acknowledged receipt of said information; and
facilitating a communication between said first device and a second device via a peer-to-peer network, in return for said confirmation.

2. The method of claim 1, wherein said second device is external to said peer-to-peer network.

3. The method of claim 2,
wherein said communication comprises a telephone call, and
wherein said facilitating comprises facilitating a connection for said telephone call.

4. The method of claim 3, wherein said connection comprises a path through a public switch telephone network.

5. The method of claim 4, wherein said information comprises an advertisement.

6. The method of claim 4, further comprising, prior to said sending:
receiving, from said first device, a message that indicates a user of said first device has consented to receive an advertisement,
wherein said sending is performed in response to said request, and
wherein said information comprises said advertisement.

7. The method of claim 3,
wherein said telephone call involves a called telephone, and
wherein said method further comprises sending an advertisement to said called telephone.

8. The method of claim 1,
wherein said communication was in progress prior to said sending, and
wherein said method further comprises, prior to said sending:
interrupting said communication;
sending, to said first device, an inquiry as to whether said user is willing to receive an advertisement in exchange for said facilitating said communication; and
receiving a response to said inquiry indicating that said user has consented to receive said advertisement,
wherein said information comprises said advertisement.

9. The method of claim 1, wherein said facilitating comprises:
crediting an account, and
debiting said account when said communication is conducted.

10. A method comprising:
presenting information via a user interface of a first device;
receiving a confirmation that a user of said first device received said information; and
facilitating a communication between said first device and a second device via a peer-to-peer network, in return for said confirmation.

11. The method of claim 10, wherein said second device is external to said peer-to-peer network.

12. The method of claim 11,
wherein said communication comprises a telephone call, and
wherein said facilitating comprises facilitating a connection for said telephone call.

13. The method of claim 12, wherein said connection comprises a path through a public switch telephone network.

14. The method of claim 13, wherein said information comprises an advertisement.

15. The method of claim 13, further comprising, prior to said presenting:
receiving a prompt indicating that said user has consented to receive an advertisement,
wherein said presenting is performed in response to said request, and
wherein said information comprises an advertisement.

16. The method of claim 15, wherein said prompt is generated by an input from said user.

17. The method of claim 12,
wherein said telephone call involves a called telephone, and
wherein said method further comprises sending an advertisement to said called telephone.

18. The method of claim 10,
wherein said communication was in progress prior to said presenting, and
wherein said method further comprises, prior to said presenting:
interrupting said communication;
presenting, via said user interface, an inquiry as to whether said user is willing to receive an advertisement in exchange for said facilitating said communication; and
receiving a response to said inquiry indicating that said user has consented to receive said advertisement,
wherein said information comprises said advertisement.

19. The method of claim 10, wherein said facilitating comprises:
crediting an account, and
debiting said account when said communication is conducted.

20. A system comprising a module that performs a method that includes:
sending information to a first device;
receiving a confirmation that a user of said first device acknowledged receipt of said information; and
facilitating a communication between said first device and a second device via a peer-to-peer network, in return for said confirmation.

21. The system of claim 20, wherein said second device is external to said peer-to-peer network.

22. The system of claim 21,
wherein said communication comprises a telephone call, and
wherein said facilitating comprises facilitating a connection for said telephone call.

23. The system of claim 22, wherein said connection comprises a path through a public switch telephone network.

24. The system of claim 23, wherein said information comprises an advertisement.

25. The system of claim 23, wherein said method further includes, prior to said sending:
receiving, from said first device, a message that indicates a user of said first device has consented to receive an advertisement,
wherein said sending is performed in response to said request, and
wherein said information comprises said advertisement.

26. The system of claim 22,
wherein said telephone call involves a called telephone, and
wherein said method further includes sending an advertisement to said called telephone.

27. The system of claim 20,
wherein said communication was in progress prior to said sending, and
wherein said method further includes, prior to said sending:
interrupting said communication;
sending, to said first device, an inquiry as to whether said user is willing to receive an advertisement in exchange for said facilitating said communication; and
receiving a response to said inquiry indicating that said user has consented to receive said advertisement,
wherein said information comprises said advertisement.

28. The system of claim 20, wherein said facilitating comprises:
crediting an account, and
debiting said account when said communication is conducted.

29. A system comprising a module that performs a method that includes:
presenting information via a user interface of a first device;
receiving a confirmation that a user of said first device received said information; and
facilitating a communication between said first device and a second device via a peer-to-peer network, in return for said confirmation.

30. The system of claim 29, wherein said second device is external to said peer-to-peer network.

31. The system of claim 30,
wherein said communication comprises a telephone call, and
wherein said facilitating comprises facilitating a connection for said telephone call.

32. The system of claim 31, wherein said connection comprises a path through a public switch telephone network.

33. The system of claim 32, wherein said information comprises an advertisement.

34. The system of claim 32, wherein said method further includes, prior to said presenting:
receiving a prompt indicating that said user has consented to receive an advertisement,
wherein said presenting is performed in response to said request, and
wherein said information comprises an advertisement.

35. The system of claim 34, wherein said prompt is generated by an input from said user.

36. The system of claim 31,
wherein said telephone call involves a called telephone, and
wherein said method further includes sending an advertisement to said called telephone.

37. The system of claim 29,
wherein said communication was in progress prior to said presenting, and
wherein said method further includes, prior to said presenting:
interrupting said communication;
presenting, via said user interface, an inquiry as to whether said user is willing to receive an advertisement in exchange for said facilitating said communication; and
receiving a response to said inquiry indicating that said user has consented to receive said advertisement,
wherein said information comprises said advertisement.

38. The system of claim 29, wherein said facilitating comprises:
crediting an account, and
debiting said account when said communication is conducted.

39. A storage medium comprising a program encoded thereon that is executable in a processor to perform a method that includes:
sending information to a first device;
receiving a confirmation that a user of said first device acknowledged receipt of said information; and
facilitating a communication between said first device and a second device via a peer-to-peer network, in return for said confirmation.

40. The storage medium of claim 29, wherein said second device is external to said peer-to-peer network.

41. The storage medium of claim 40,
wherein said communication comprises a telephone call, and
wherein said facilitating comprises facilitating a connection for said telephone call.

42. The storage medium of claim 41, wherein said connection comprises a path through a public switch telephone network.

43. The storage medium of claim 42, wherein said information comprises an advertisement.

44. The storage medium of claim 42, wherein said method further includes, prior to said sending:
receiving, from said first device, a message that indicates a user of said first device has consented to receive an advertisement,
wherein said sending is performed in response to said request, and
wherein said information comprises said advertisement.

45. The storage medium of claim 41,
wherein said telephone call involves a called telephone, and
wherein said method further includes sending an advertisement to said called telephone.

46. The storage medium of claim 39,
wherein said communication was in progress prior to said sending, and
wherein said method further includes, prior to said sending:
interrupting said communication;
sending, to said first device, an inquiry as to whether said user is willing to receive an advertisement in exchange for said facilitating said communication; and
receiving a response to said inquiry indicating that said user has consented to receive said advertisement,
wherein said information comprises said advertisement.

47. The storage medium of claim 39, wherein said facilitating comprises:
crediting an account, and
debiting said account when said communication is conducted.

48. A storage medium comprising a program encoded thereon that is executable in a processor to perform a method that includes:
presenting information via a user interface of a first device;
receiving a confirmation that a user of said first device received said information; and
facilitating a communication between said first device and a second device via a peer-to-peer network, in return for said confirmation.

49. The storage medium of claim 48, wherein said second device is external to said peer-to-peer network.

50. The storage medium of claim 49,
wherein said communication comprises a telephone call, and
wherein said facilitating comprises facilitating a connection for said telephone call.

51. The storage medium of claim 50, wherein said connection comprises a path through a public switch telephone network.

52. The storage medium of claim 51, wherein said information comprises an advertisement.

53. The storage medium of claim 51, wherein said method further includes, prior to said presenting:
receiving a prompt indicating that said user has consented to receive an advertisement,
wherein said presenting is performed in response to said request, and
wherein said information comprises an advertisement.

54. The storage medium of claim 53, wherein said prompt is generated by an input from said user.

55. The storage medium of claim 50,
wherein said telephone call involves a called telephone, and
wherein said method further includes sending an advertisement to said called telephone.

56. The storage medium of claim 48,
wherein said communication was in progress prior to said presenting, and
wherein said method further includes, prior to said presenting:
interrupting said communication;
presenting, via said user interface, an inquiry as to whether said user is willing to receive an advertisement in exchange for said facilitating said communication; and
receiving a response to said inquiry indicating that said user has consented to receive said advertisement,
wherein said information comprises said advertisement.

57. The storage medium of claim 48, wherein said facilitating comprises:
crediting an account, and
debiting said account when said communication is conducted.
